(19) United States
(12) Patent Application Publication
(10) Pub. No.: US 2010/0069550 A1
(43) Pub. Date: Mar. 18, 2010

(54) NANOPARTICLE ASSEMBLIES AND METHODS FOR THEIR PREPARATION

(75) Inventors: Xiaohu Gao, Shoreline, WA (US); Jian Yang, Guangzhou (CN)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: WASHINGTON, UNIVERSITY OF, Seattle, WA (US)

(21) Appl. No.: 12/405,520

(22) Filed: Mar. 17, 2009

Related U.S. Application Data
(60) Provisional application No. 61/037,280, filed on Mar. 17, 2008.

(51) Int. Cl. C08G 67/04; C08K 3/22

(52) U.S. Cl. 524/401; 524/500; 524/599; 977/774

(57) ABSTRACT

Nanoparticle assemblies comprising a plurality of nanoparticles and an amphiphilic polymer, and methods for making and using the nanoparticle assemblies.

CROSS-REFERENCE TO RELATED APPLICATION

This application claims the benefit of U.S. Provisional Patent Application No. 61/037,280, filed Mar. 17, 2008, incorporated herein by reference in its entirety.

### STATEMENT OF GOVERNMENT LICENSE RIGHTS

This invention was made with Government support under Contract No. R01CA131797 awarded by the National Institutes of Health and under Contract No. 0645080 awarded by the National Science Foundation. The Government has certain rights in the invention.

### BACKGROUND OF THE INVENTION

The development of fluorescent probes that are stable, compact, and significantly brighter than traditional fluorophores (e.g., organic dyes and fluorescent proteins) is of considerable interests to many research areas including DNA sequencing, gene expression profiling, molecular imaging, fundamental biophysics, as well as clinical diagnostics. Despite recent success with semiconductor quantum dots (QDs), which are 20-50 times brighter than single dye molecules, fluorescent probes with improved brightness and multiplexing capability are highly desirable for analysis of low-abundance targets in bioassays including single molecule detection, immunoassays, and fluorescence in situ hybridization, and for understanding of complex human diseases involving a large number of genes and proteins (e.g., cancer and atherosclerosis).

In this context, optical encoding technologies by multiplexing colors and fluorescence intensities of fluorophores have become an attractive strategy because a large number of high-brightness probes can be readily produced. Compared with organic fluorophores, semiconductor QDs are of particular importance to this application because of their favorable optical properties such as simultaneous excitation of multiple colors with a single light source, minimal spectral overlap between adjacent colors, and remarkable photostability. For example, QD-tagged optical barcodes have been prepared by incorporating multicolor QDs into mesoporous microspheres at predefined intensity ratios. The use of 10 intensity levels of 6 colors has a theoretical coding capacity of one million (10⁶). The encoded microspheres are highly fluorescent and uniform, because they typically contains 5,000-10 million QDs per bead depending on the microbead size and doping level. This remarkable nanoparticle doping capacity has also captivated scientists to develop alternative preparation methods (e.g., nanoparticle layer-by-layer deposition) and improved readout apparatus. Unfortunately, because of the large size (typically 1-15 μm), these QD-doped microspheres are not suitable for applications such as gene, protein and cell labeling.

Toward the development of uniform and bright QD-encoded beads in the nanometer regime, a few attempts have been made. Most common reaction schemes include encapsulation of nanoparticles in silica beads, hydrogels, and block-copolymer micelles. However, these existing methods are limited by low nanoparticle loading capacity, fluorescence quenching or broad size distribution. For example, QD-doped silica beads can be made with low size distribution, but only a small number of QDs can be incorporated, and their quantum efficiency is often significantly reduced (75% decrease). This is because the optical properties of QDs are highly sensitive to the environment in contrast to embedded metallic and magnetic nanoparticles. In this regard, the block copolymer-based micelle formation should be more attractive because high-quality QDs (prepared in organic solvents at elevated temperatures) are generally clustered in the hydrophobic core of block copolymer micelle. On the other hand, the micelle size distribution are much broader than silica nanobeads, and the number of QDs can be encapsulated is still limited.

Despite the advances in the development of QD-based materials and because multicolor doping with tunable fluorescence intensity ratios and low level of fluorophore self-quenching in the nanometer regime has not been achieved, there exists a need for new methods that simultaneously achieve the high brightness and narrow size dispersity for wide-spread application of the nanobeads in fluorescence-based imaging and detection. The present invention seeks to fulfill these needs and provides further related advantages.

### SUMMARY OF THE INVENTION

In one aspect of the invention, a nanoparticle assembly is provided. In one embodiment, the nanoparticle assembly includes a plurality of nanoparticles; and an amphiphilic polymer. Representative nanoparticles include quantum dots, metal nanoparticles, metal oxide nanoparticles, metalloid nanoparticles, metalloid oxide nanoparticles, and combinations thereof.

In one embodiment, the nanoparticles are single color quantum dots. In another embodiment, the nanoparticles are multicolor quantum dots.

In one embodiment, the amphiphilic polymer is an amphiphilic alternating copolymer. In another embodiment, the amphiphilic polymer is an amphiphilic random copolymer. In a further embodiment, the amphiphilic polymer is an amphiphilic block copolymer.

In one embodiment, the amphiphilic polymer is a crosslinked amphiphilic polymer.

In one embodiment, the nanoparticle assembly includes up to about 250,000 nanoparticles.

In another aspect, the invention provides a method for making a nanoparticle assembly. In one embodiment, the method includes providing a mixture of nanoparticles and an amphiphilic polymer in a first solvent; and adding a second solvent to the mixture in a quantity sufficient to provide a nanoparticle assembly comprising the nanoparticles and amphiphilic polymer, wherein the first and second solvents are miscible, and wherein the polarity of the second solvent differs from the polarity of the first solvent.

In one embodiment, the method further includes crosslinking the nanoparticle assembly to provide a crosslinked nanoparticle assembly. Crosslinking the nanoparticle assembly can include crosslinking the amphiphilic polymer of the assembly.

In one embodiment, when the amphiphilic polymer includes anhydride moieties, the method further includes hydrolyzing at least a portion of the anhydride groups of the amphiphilic copolymer to provide a nanoparticle assembly having a plurality of carboxylic acid moieties.

In one embodiment, the ratio of nanoparticles to amphiphilic polymer is from about 10:1. In another embodiment, the ratio of nanoparticles to amphiphilic polymer is from about 1:1,000.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A provides schematic illustrations of a representative quantum dot and a representative amphiphilic polymer useful for making the nanoparticle assembly of the invention.

FIG. 1B is a schematic illustration of nanoparticle assembly formation in accordance with the method of the invention. Single QDs are coated with a amphiphilic polymer (poly(maleic anhydride-octadecene), PMAO). The QD-polymer complexes form uniform nanoparticle assemblies as a result of increasing solvent polarity. The nanoparticle assemblies can be further stabilized by crosslinking of polymer chains with diamines.

FIG. 1C is illustrates representative nanoparticle assembly formation monitored by dynamic light scattering (DLS) measurements. QD-polymer complexes are dispersed when DMF concentration is under 20% in volume. Increasing DMF concentration from 20% to 30% leads to quick formation of QD-nanoparticle assemblies as indicated by the size increase from approximately 10 nm to 100 nm. In comparison, QDs alone start to form irregular nanoparticle aggregates when DMF reaches a concentration of about 5%. The delayed aggregation process of QD and PMAO mixture indicates that the polymers interact with QDs leading to formation of QD-PMAO hybrid structure with reduced hydrophobicity compared to original QDs.

FIG. 1D is a fluorescence measurement showing the QD incorporation efficiency. Nanoparticle assemblies were removed by centrifugation, and the supernatants were measured on a fluorometer (lower curve). Fluorescence spectra indicate that more than 95% of the QDs are incorporated into the nanoparticle assemblies.

FIG. 2A shows the emission spectra of monochromatic QD-nanoparticle assemblies emitting light at 525 nm, 550 nm, 565 nm, 585 nm, and 620 nm.

FIGS. 2B-2F are fluorescent micrographs of the QD-nanoparticle assemblies (525, 550, 565, 585, and 620 nm emitters, respectively) dispersed on coverslips. FIG. 2G is a fluorescent image of a control experiment showing the importance of the PMAO polymer. Without the polymer, QDs form aggregates of irregular shapes and sizes.

FIG. 3A are TEM images showing the size of representative red nanoparticle assemblies is 92±13 nm. Individual QDs can be resolved when imaged at high-magnification (inset).

FIG. 3B is a DLS measurement indicating the hydrodynamic diameter of the representative nanoparticle assemblies in aqueous buffer is 112±18 nm.

FIG. 3C is a fluorescent micrograph of the representative nanoparticle assemblies confirming their low size dispersity and high brightness.

FIG. 3D is a spectroscopic measurement comparing the fluorescence emission of the representative nanoparticle assemblies and original QDs in THF. Identical fluorescence emission spectra were observed for single QDs and QDs embedded inside the nanoparticle assemblies.

FIG. 4A are TEM images showing the size of representative green nanoparticle assemblies. Individual QDs can be resolved when imaged at high-magnification (inset).

FIG. 4B is a DLS measurement indicating the hydrodynamic diameter of the representative nanoparticle assemblies in aqueous buffer.

FIG. 4C is a fluorescent micrograph of the representative nanoparticle assemblies confirming their low size dispersity and high brightness.

FIG. 4D is a spectroscopic measurement comparing the fluorescence emission of the representative nanoparticle assemblies and original QDs in THF. The results are very similar to those of the red QD-nanoparticle assemblies shown in FIG. 3D, except that a slight spectral shift toward longer wavelength was observed.

FIG. 5 is a schematic illustration of two adjacent QDs inside a representative crosslinked nanoparticle assembly of the invention.

FIGS. 6A-6F present fluorescence imaging (6A-6C) and emission spectra (6D-6F) of representative dual-color QD-encoded nanoparticle assemblies of the invention: three nanobarcodes with green-to-red intensity ratios of 2:1, 1:1, and 1:2, respectively. FIG. 6G is a scatter plot of the 1:2 intensity ratio of individual nanobarcodes measured by hyperspectral imaging technique. The values are tightly clustered around the average at 0.44.

FIG. 7A is a schematic illustration of a fluorescence immunoassay for PSA detection using representative QD-nanoparticle assemblies of the invention. Bioconjugates of QD-nanoparticle assemblies and streptavidin are used as the reporter probe.

FIG. 7B is curve illustrating the immunoassay showing fluorescence emission of QD-nanoparticle assemblies as a function of PSA concentration. Autofluorescence of the microplate imaged under the same condition was subtracted from the fluorescence intensity values. Sub-nanomolar PSA can be readily detected using a standard optical plate reader.

FIG. 8 is a bar graph comparing negative control experiments to the QD-nanoparticle assembly immunoassay for PSA detection. In the absence of capture antibody (first bar), PSA target molecule (second bar), or secondary antibody (third bar) were missing in the assay, the fluorescence intensity was in the background level indicating specific detection of PSA using QD-nanoparticle assemblies (fourth bar).

### DETAILED DESCRIPTION OF THE INVENTION

The present invention provides nanoparticle assemblies, and methods for making and using the nanoparticle assemblies.

In one aspect, the invention provides a nanoparticle assembly that includes a plurality of nanoparticles; and an amphiphilic polymer. As used herein, the term “nanoparticle assembly” is used interchangeably with the term “nanobead.”

Representative nanoparticles that can be used incorporated into the assembly include quantum dots (i.e., semiconductor nanoparticles), metal nanoparticles, metal oxide nanoparticles, metalloid nanoparticles, metalloid oxide nanoparticles. The assemblies of the invention can include one or more of the nanoparticles described above (i.e., the assembly can include a single type of nanoparticle, or a combination of types of nanoparticles). In one embodiment, the nanoparticles are magnetic nanoparticles. In one embodiment, the metal and metal oxide nanoparticles are selected from the group consisting of gold, silver, copper, titanium, and oxides thereof. In another embodiment, the metal and metal oxide nanoparticles are lanthanide series metal nanoparticles.

As noted above, representative nanoparticles include quantum dots. In one embodiment, the nanoparticles are single color quantum dots. In another embodiment, the nanoparticles are multicolor quantum dots. Suitable quantum dots include those known to those of skill in the art and include those that are commercially available. Other suitable quantum dots include those described in U.S. Pat. Nos. 5,906,670, 5,888,885, 5,229,320, 5,482,890, 6,468,808, 6,306,736, and 6,225,198, the description of these quantum dots and their preparations are incorporated herein by reference.

To facilitate formation of the nanoparticle assemblies of the invention and to provide an advantageous associative interaction with the amphiphilic polymer of the assembly, the nanoparticles have a hydrophobic surface. The hydrophobic surfaces can be prepared by coating the nanoparticle with a hydrophobic ligand. Suitable hydrophobic surfaces include surfaces having hydrocarbon components. For example, the nanoparticle can be a hydrophobic ligand coated nanoparticle (e.g., quantum dot). The hydrophobic coated nanoparticle can be coated with a chemical compound such as, but not limited to, an O═PR₃ compound, an O═PHR₂ compound, an O═PHR₁ compound, a H₂NR compound, a HNR₂ compound, a NR₃ compound, a HSR compound, a SR₂ compound, and combinations thereof. In the above chemical compounds, “R” can be a C₁ to C₂₄ hydrocarbon, such as but not limited to, linear hydrocarbons, branched hydrocarbons, cyclic hydrocarbons, substituted hydrocarbons (e.g., halogenated), saturated hydrocarbons, unsaturated hydrocarbons, and combinations thereof. A combination of R groups can be attached to P, N, or S. In particular, the chemical can be selected from tri-octylphosphine oxide, stearic acid, and octyldecyl amine.

The size of the nanoparticle incorporated into the assembly can be varied. In one embodiment, the nanoparticles have a diameter of from about 1 to about 100 nm. In another embodiment, for example when the nanoparticle is a quantum dot, the nanoparticles have a diameter of from about 1 to about 10 nm.

In addition to including a plurality of nanoparticles, the assemblies of the invention include an amphiphilic polymer having a plurality of hydrophobic moieties, which advantageously interact associatively with the nanoparticles having a hydrophobic surface. A large number of amphiphilic polymers are suitable for the nanoparticle assembly synthesis. Amphiphilic polymers include two functional segments: a hydrophilic segment and a hydrophobic segment. The hydrophilic segments of amphiphilic polymers can be made from water-soluble monomers (e.g., monomers containing —COOH, —NH₂, —OH, or —OC₂H₄— chemical groups) and the hydrophobic segments can include hydrocarbons (linear, branched, or cyclic) or aromatic groups (e.g., benzene ring). Suitable amphiphilic copolymers include hydrophilic anhydride moieties and hydrophobic hydrocarbon moieties. In one embodiment, the amphiphilic polymer is an amphiphilic alternating copolymer. In another embodiment, the amphiphilic polymer is an amphiphilic random copolymer. In a further embodiment, the amphiphilic polymer is an amphiphilic block copolymer.

In one embodiment, the hydrocarbon moiety can include an alkyl, an aryl moiety, or an aralkyl moiety. Suitable alkyl moieties include linear, branched, and cyclic alkyl moieties. Representative alkyl moieties include C1-C24 n-alkyl moieties. In one embodiment, the alkyl moiety is a C16 n-alkyl moiety.

In one embodiment, the amphiphilic polymer is an amphiphilic alternating copolymer. Suitable amphiphilic alternating copolymers include hydrophilic anhydride moieties and hydrophobic hydrocarbon moieties. A representative amphiphilic alternating copolymer useful in the invention is a poly(maleic anhydride-octadecene) (PMAO) having an average molecular weight of about 40,000 g/mole.

Suitable amphiphilic polymers have an average molecular weight of from about 500 to about 5,000,000 g/mole. In one embodiment, the amphiphilic polymer has an average molecular weight of from about 5,000 to about 500,000 g/mole. A representative amphiphilic alternating copolymer useful in the invention is a poly(maleic anhydride-octadecene) (PMAO) having an average molecular weight of about 40,000 g/mole.

To enhance the stability of the nanoparticle assembly and depending on the amphiphilic polymer, the assembly can be a crosslinked assembly. In the crosslinked assembly, the amphiphilic polymer is crosslinked. For example, for an assembly including an amphiphilic polymer having anhydride or carboxylic acid groups, the polymer can be crosslinked by reaction with a diamine to provide diamide crosslinks. Assemblies that include large amphiphilic polymers may be sufficiently stable and may not need to be crosslinked to further enhance their stability.

The nanoparticle assembly of the invention can vary in size. In one embodiment, the assembly diameter is from about 10 to about 1000 nm.

The number of nanoparticles incorporated into the nanoparticle assembly can be widely varied and depends on assembly size and nanoparticle density. In certain embodiments, up to about 250,000 nanoparticles can be incorporated into the assembly. For assemblies having a diameter less than about 1000 nm, the assembly can include up to about 250,000 dots. For assemblies having a diameter of about 100 nm, the assembly can include from about 10 to about 1000 dots.

By virtue of the nature of the nanoparticle assembly of the invention, the invention provides nanobarcodes. The simplest nanobarcode provided by the invention is a single color quantum dot encoded assembly. In such an assembly, the quantum dots can have different fluorescence intensities. In a multicolor scheme, the ratio of each color can be varied. For example, in a two color scheme the ratios can be 1:1, 1:2, or 2:1, and in a three color scheme the ratios can be 1:1:1, 1:2:1, 2:1:2. Theoretically, tens of colors can be embedded into a batch of assemblies. In certain embodiments, five colors can be incorporated into an assembly batch.

In another aspect, the invention provides a method for making nanoparticle assemblies. In one embodiment, the method includes providing a mixture of nanoparticles and an amphiphilic polymer in a first solvent; and adding a second solvent to the mixture in a quantity sufficient to provide a nanoparticle assembly comprising the nanoparticles and amphiphilic polymer. In the method, the first and second solvents are miscible, and the polarity of the second solvent differs from the polarity of the first solvent. The first solvent (e.g., non-polar solvent such as tetrahydrofuran) may have a polarity that is less than the polarity of the second solvent (e.g., polar solvent such as dimethylformamide). Alternatively, the polarity of the first solvent can be greater than the polarity of the second solvent. The nanoparticles and amphiphilic polymer are suspendable with substantially no nanoparticle aggregation in the first solvent, and on addition of the second solvent, aggregation occurs to provide the nanoparticle assemblies.

Representative first solvents include tetrahydrofuran, chloroform, methylene chloride, hexane, ethyl acetate, diethyl ether, benzene, and toluene. Representative second solvents include methanol, ethanol, acetone, acetonitrile, dimethylsulfoxide, and dimethylformamide. Mixtures of solvents can also be used.

The nanoparticles and amphiphilic polymers useful in the method are those described above.

In one embodiment, the method further include crosslinking the nanoparticle assembly to provide a crosslinked nanoparticle assembly. In this embodiment, crosslinking the nanoparticle assembly comprises crosslinking the amphiphilic polymer of the assembly.

Suitable crosslinking agents include bifunctional, trifunctional, or multifunctional agents that are capable of reacting with the amphiphilic polymer. As noted above, when the amphiphilic copolymer includes anhydride moieties or carboxylic acid moieties, the crosslinking agent may be a diamine.

In one embodiment, when the amphiphilic copolymer of the assembly includes anhydride moieties, the assembly can be hydrolyzed to provide an assembly having a plurality of carboxylic acid groups. Such an assembly can be readily used in biological applications where water solubility is important.

In the method, the ratio of nanoparticles to polymer can be varied depending on the size and nature of the nanoparticle and polymer. For example, for relatively small diameter nanoparticles (e.g., 1-10 nm) and relatively large molecular weight polymers, the ratio of nanoparticles to amphiphilic polymer is from about 10:1. For relatively large diameter nanoparticles (e.g., 100 nm) and relatively small molecular weight polymers, the ratio of nanoparticles to amphiphilic polymer is from about 1:1000.

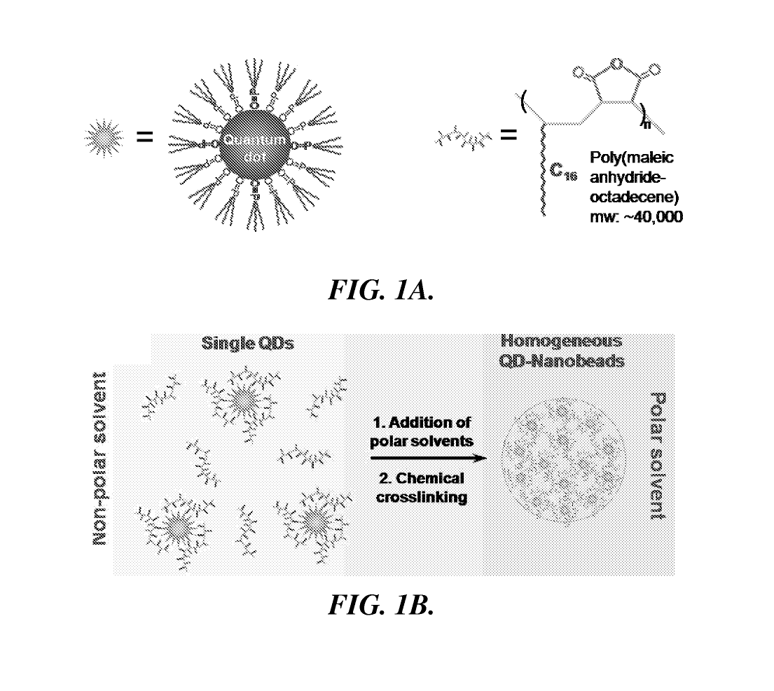

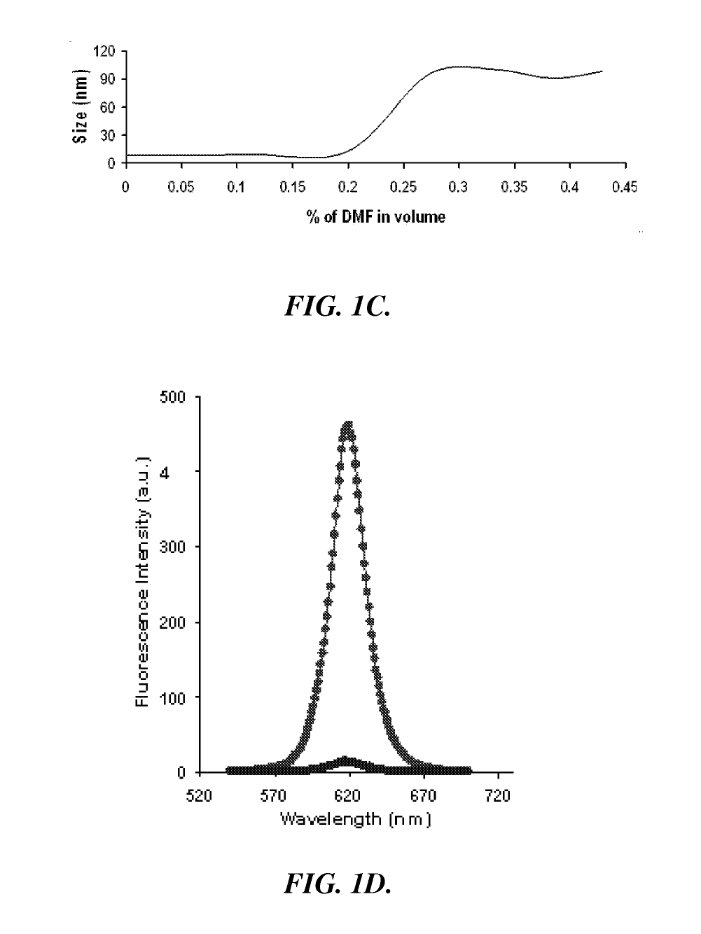

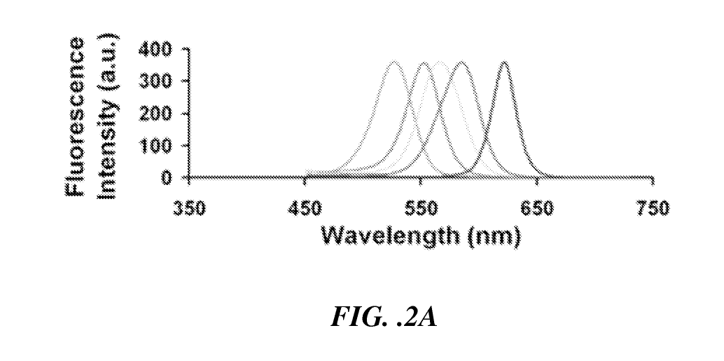

The present invention provides a new approach for the preparation of nanoparticle assemblies (e.g., QD-tagged nanobeads) based on epitaxial growth of nanoparticle-amphiphilic polymer complexes in homogeneous solution. This new generation of fluorescent probe is uniform in size, thousands of times brighter than single organic dyes, stable against photobleaching, and free of ‘blinking’ effect. The nanobeads of the invention include an amphiphilic alternating copolymer that is not only capable of coating multicolor QDs, but also capable of preventing their aggregation into irregular agglomerates. In contrast to nanoparticles clustered inside block copolymer micelles, the QDs in the nanobeads are pre-protected by the amphiphilic alternating polymers and thus preventing them from physically contacting each other. See FIG. 1A for schematic illustrations of a representative nanoparticle (e.g., quantum dot) and a representative amphiphilic copolymer (PMAO) useful for making the nanoparticle assemblies of the invention. The QD-polymer complexes self-assemble epitaxially into nanobeads with QDs distributed inside homogeneously. This process is similar to the growth of nanocrystals except that the building blocks are not ions or small molecules, but are nanoparticles (QDs). As schematically illustrated in FIG. 1B, QDs and poly(maleic anhydride-octadecene) (PMAO) bond to each other via multivalent hydrophobic interactions. The QD-PMAO conjugates are highly soluble in tetrahydrofuran (THF), but form aggregates in polar solvents such as dimethylformamide (DMF). A solvent gradient created by slow addition of DMF into THF leads to epitaxial growth of highly fluorescent nanobeads with narrow size dispersity. In this process, the PMAO polymer plays a role in controlling the nanobead size and size distribution.

QD-polymer hybrid structures have been previously reported for solubilization of single hydrophobic QDs. A simple and versatile procedure for solubilization of hydrophobic semiconductor, metallic, and oxide nanoparticles using low-molecular weight poly(maleic anhydride-tetradecene) (M_{w} about 9,000) has been reported (Pellegrino et al., Nano Lett 2004, 4, 703-707). However, in the present invention, the amphiphilic copolymers useful in forming the nanobeads of the present invention have average molecular weights greater than about 10,000 g/mole. In certain embodiments, the amphiphilic copolymers have average molecular weights from about 30,000 to about 50,000 g/mole (i.e., M_{w} 30,000-50,000). Furthermore, the amphiphilic copolymers useful in the making the nanobeads of the invention are insoluble in aqueous buffers.

Using single color QDs, the conditions for nanoparticle assembly formation were systematically investigated. Dynamic light scattering measurements indicate that QDs remain single in THF/DMF solvent mixture when DMF concentration is under 20% in volume (FIG. 1C). Increasing DMF concentration from 20% to 30% leads to spontaneous formation of QD-nanobeads as indicated by the size shift from approximately 10 nm to 100 nm. This self-assembly process is highly efficient at encapsulating QDs. Fluorescence measurement of single QDs left in the supernatant after isolation of nanobeads by centrifugation indicates that more than 95% of QDs are incorporated into the nanobeads (FIG. 1D). To further enhance the nanobead stability, such as preventing potential QD leaching or release in bioassays, the polymer chains in the nanobeads are crosslinked with small-molecule diamines. Due to the rich anhydride contents in PMAO polymer and the high reactivity between anhydrides and primary amines, no catalytic reagents are needed to crosslink the polymers into a stable network. Following the nanobead formation, the resulting fluorescent nanobeads can be made water-soluble for biological applications. Nanobeads isolated by centrifugation cannot be directly suspended in aqueous buffers. This is understandable because majority of the anhydride groups are not hydrolyzed into carboxylic acids, and thus the nanobeads are not sufficiently hydrophilic. Using dialysis against Tris buffer (containing 20 mM Tris(hydroxymethyl)aminomethane) provided efficient hydrolysis of the anhydride groups as the solvents gradually change from THF/DMF mixture to aqueous solution. The resulting nanoparticle assemblies having carboxylic acid groups are stable in aqueous buffers for at least several months.

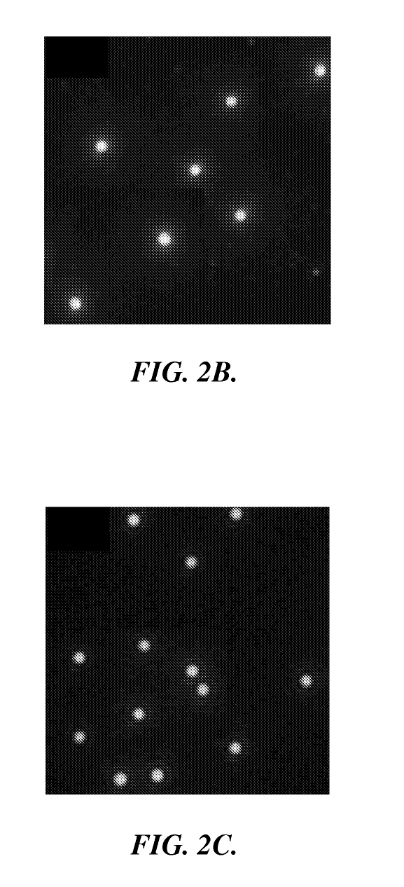

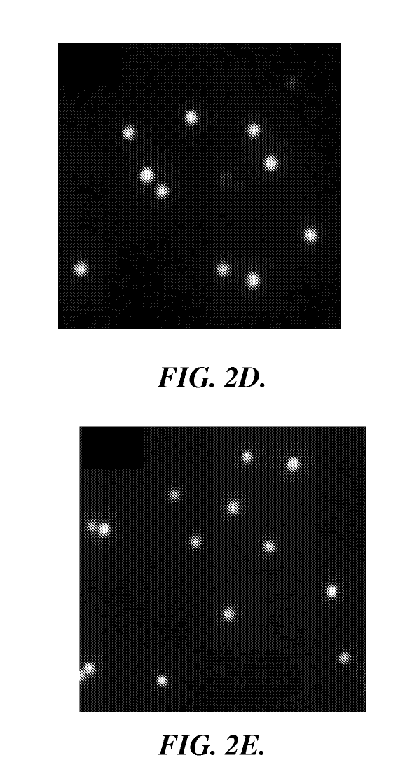

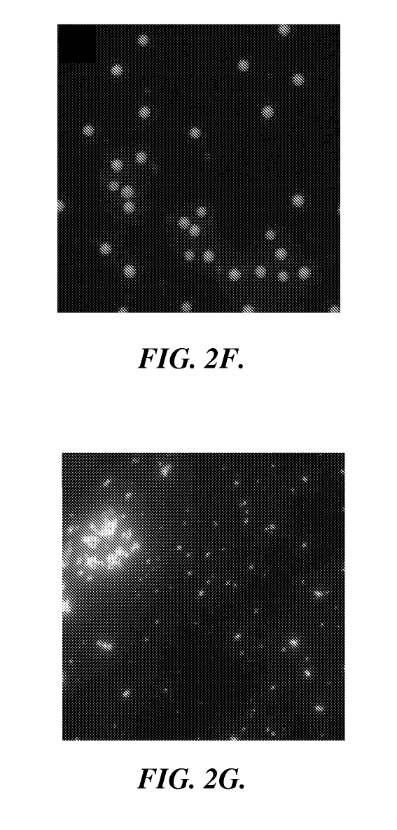

FIG. 2A shows the emission spectra of a series of representative water-soluble nanoparticle assemblies of the invention, each containing single-color QDs. The nanobeads are uniform in size and highly luminescent. The sizes of these monochrome nanobeads are about 100 nm in diameter, which is suitable for molecular and cellular labeling. Single-particle fluorescence spectroscopy reveals that the nanobeads are significantly brighter than the constituting single QDs. This remarkable brightness can be attributed to the large number of QDs incorporated because the QDs self-assemble into nanobeads in homogeneous solutions without any structural template. The microscopic images (FIGS. 2B-2G) were obtained using a single light source, a mercury lamp. Simultaneous excitation of multiple colors is a unique optical property of QDs and will have significant impact on bioassays such as fluorescence cross-correlation spectroscopy (FCCS), because co-focusing of two or more laser beams is an exceedingly difficult task due to chromatic and spherical aberrations of microscope objective. Indeed, this has been a major problem for dual-probe based imaging and detection when organic dyes or organic dye-labeled nanobeads are used.

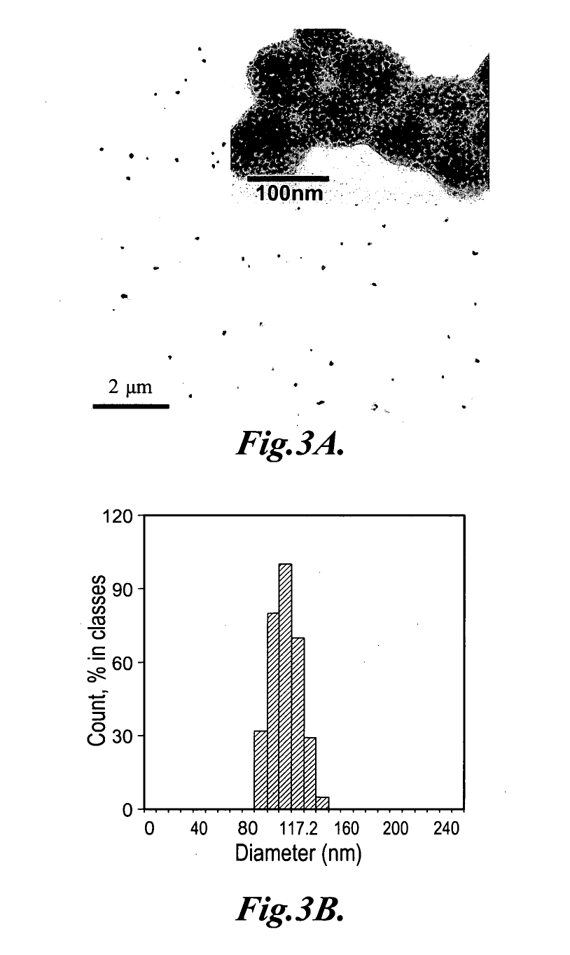

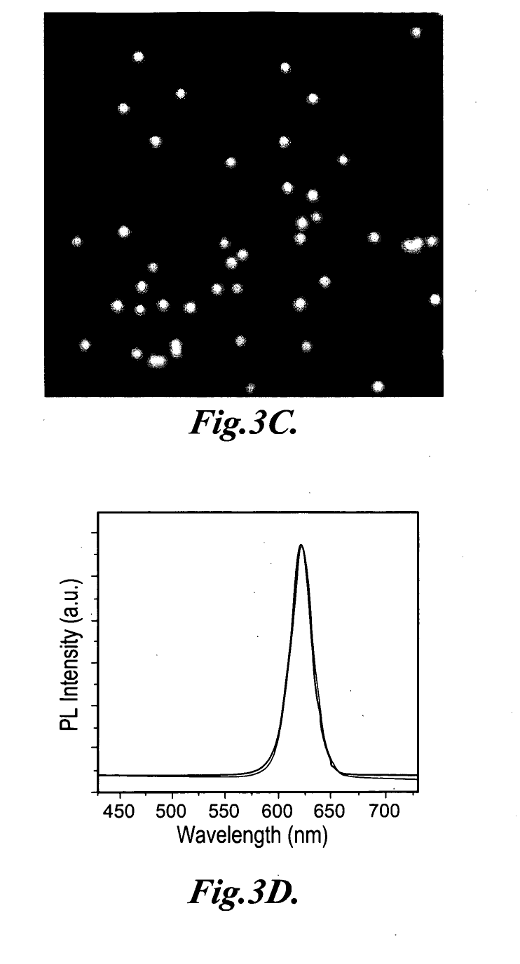

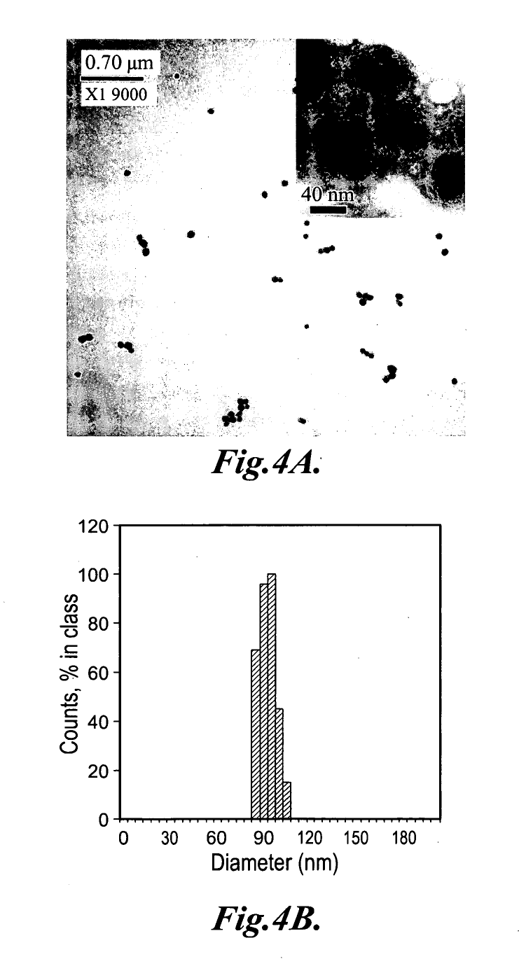

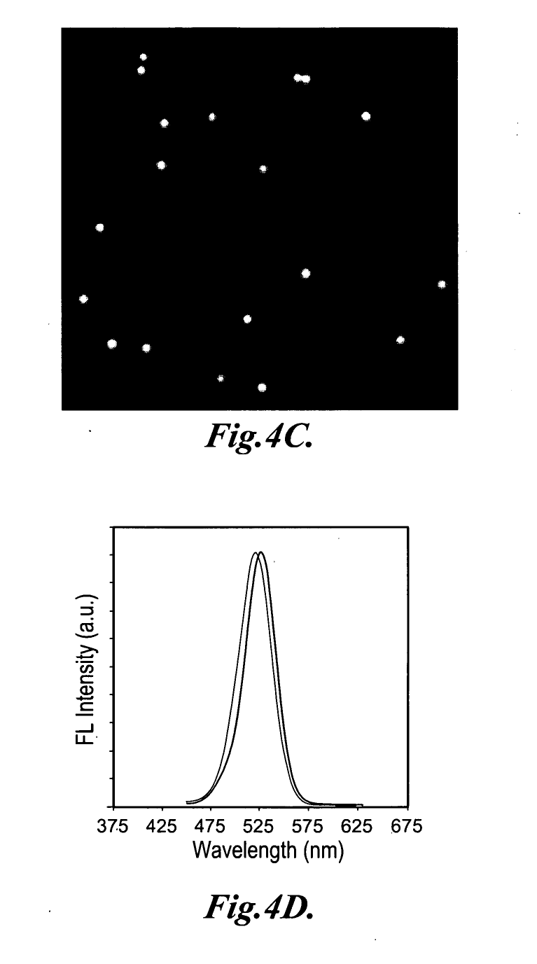

The structural and optical properties of representative nanoparticle assemblies (e.g., QD-nanobeads) of the invention were characterized. The size of red QD-doped nanobeads was measured by both transmission electron microscopy (TEM) and dynamic light scattering (DLS). The ‘dry’ size of the nanobeads measured by TEM is 92±13 nm (FIG. 3A), whereas the DLS measurement indicates that the hydrodynamic size of nanobeads in solution is 112±18 nm (FIG. 3B). The discrepancy between the two measurements could be attributed to two effects. First, because the nanobeads are made from polymer-coated QDs that are inter-connected, they are unlikely to be rigid structures in solution. When the solvent is dried (such as the condition of TEM measurement), the polymer-coated QDs could collapse closer to each other, which renders the nanobeads to shrink. Second, the nanobeads are highly negatively charged in aqueous buffer due to the abundant carboxylic acid groups. This negative surface charge not only prevents nanobeads from aggregation, but also creates an electrical double layer in aqueous buffers, thereby slightly increasing the colloidal hydrodynamic radius compared to the actual size.

Fluorescence imaging confirms the low size dispersity of the nanoparticle assemblies. As shown in FIG. 3C, the red QD-doped nanobeads are uniform and highly fluorescent. Wavelength-resolved spectroscopy measurement of single nanobeads indicates that the nanobeads are as bright as approximately 200 single QDs (FIG. 3D). This number is calculated by dividing the average fluorescence intensity of nanobeads by that of the single QDs. Statistical analysis of a population of more than 100 nanobeads shows that the standard deviation of their fluorescence intensity is 30%. This value is close to the calculated variation of the nanobead volume using its radius (24% variation based on TEM and 28% variation based on DLS), suggesting that the observed fluorescence signal variation is mainly determined by the nanobead size uniformity. Although this intensity distribution is not as tight as the values reported for QD-doped microspheres (typically 3-15%), it is substantially improved over the micelle-based QD nanobeads. In general, preparation of nanobeads with highly uniform fluorescence intensity is extremely difficult because of the small number of QDs that can be incorporated relative to microspheres. As a consequence, small variations in bead sizes and spectroscopy measurement conditions, in addition to shot noise, will translate into significant variance in single-bead fluorescence intensity.

The parameters that control nanoparticle assembly size and size distribution are not entirely understood. Above a critical DMF concentration, QD-PMAO cluster into nanobeads due to their low solubility in DMF. The PMAO molecules distributed at the interface of nanobeads and the solvent mixture help lower the interfacial energy. The nanobeads are unlikely to be equilibrium structures, which favor the formation of large agglomerates. Therefore, the size and tight size distribution might be controlled by kinetics in which high percentage of DMF (in one embodiment about 30%) freezes the growth of nanobeads at a certain size leading to formation of uniform and stable QD clusters. If nanobead formation is controlled by kinetics, their size and size dispersity will be tunable by changing experiment conditions such as polymer composition, nanoparticle and polymer concentrations, and the rate of polar solvent addition.

The fluorescent micrograph (FIG. 3C) also shows that the QD-nanobeads do not ‘blink’ under continuous excitation. The blinking effect is characteristic of single quantum systems such as single dye molecules and single QDs, and this on-and-off behavior could be problematic for detection and imaging of fast biological processes, such as biomolecular transport and trafficking. Although individual QDs exhibit fluorescence intermittency, the nanobeads, which contain an ensemble of QDs, collectively have constant fluorescence intensity.

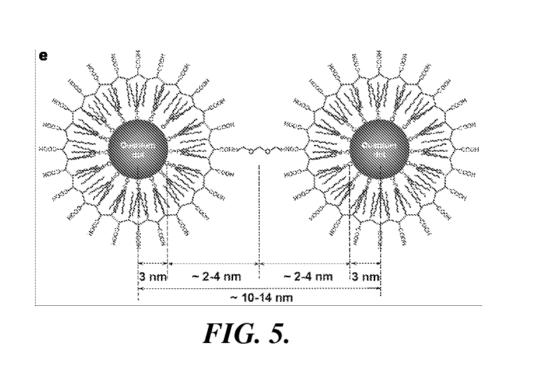

A number of QDs are incorporated into each nanobead. TEM measurements at high magnification can resolve individual QDs (inset of FIG. 3A), but the image is a 2-D representation of a 3-D structure, which makes it impossible to count the number of QDs per bead. The number of QDs are incorporated into each nanobead was determined based on optical properties. Comparison of the fluorescence quantum efficiency (QE) of the nanobeads and the original single QDs in THF indicates that the QE of nanobeads is 25% lower than that of QDs, which is typically around 30-40% (QD concentration in the nanobead samples was first derived from the UV absorption measurement and then the fluorescence intensity was then evaluated for QD solution and nanobead solution at the same absorbance value). The QE reduction is likely resulted from concentration-dependent fluorophore self-quenching, a phenomenon first observed in the 1880s. When fluorophores are in close proximity to each other, such as under high concentration, the fluorescence intensity does not increase linearly with increasing concentration of fluorophores and may even decrease. Because the fluorescence intensity of single nanobeads is as bright as 200 single QDs (see the single bead spectroscopy measurement discussed above) and because their QE is 25% lower than single QDs, we estimated that each nanobead of 112 nm in diameter is packed with 267 QDs (200/[1-25%]). Despite the variance in QD spacing, this calculation suggests that average distance between two adjacent QDs is approximately 14 nm (center to center), which matches the result of theoretical analysis of the particle packing geometry (schematically illustrated in FIG. 5). Considering the radius of red QDs of 3 nm and the intercalating hydrocarbon layer from QD surface ligands and PMAO polymer of 2-4 nm in thickness, the overall distance between two QDs (center to center) will be approximately 10-15 nm, which is also equivalent to the diameter of the a polymer coated QD. Additional optimization of this technology to reduce or eliminate the QD self quenching may be achieved by increasing the separation distance between QDs, such as by using amphiphilic polymers grafted with longer side chains.

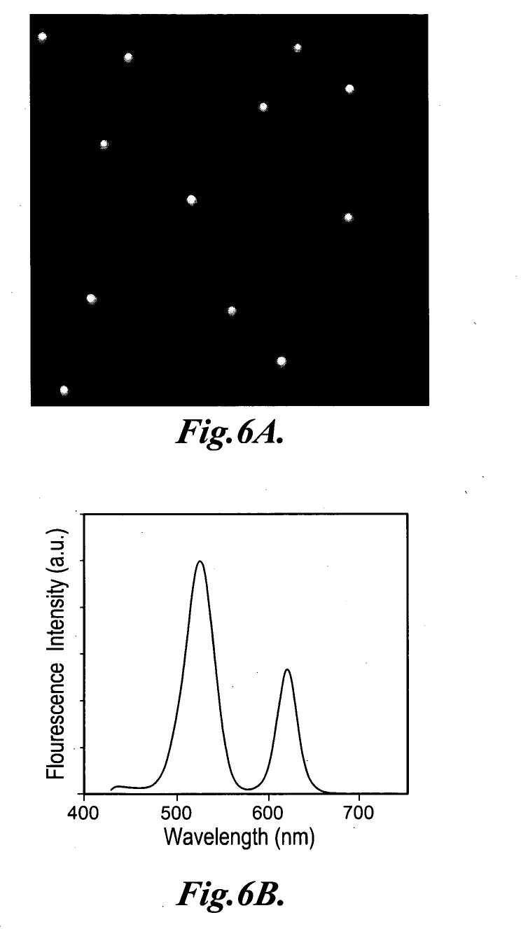

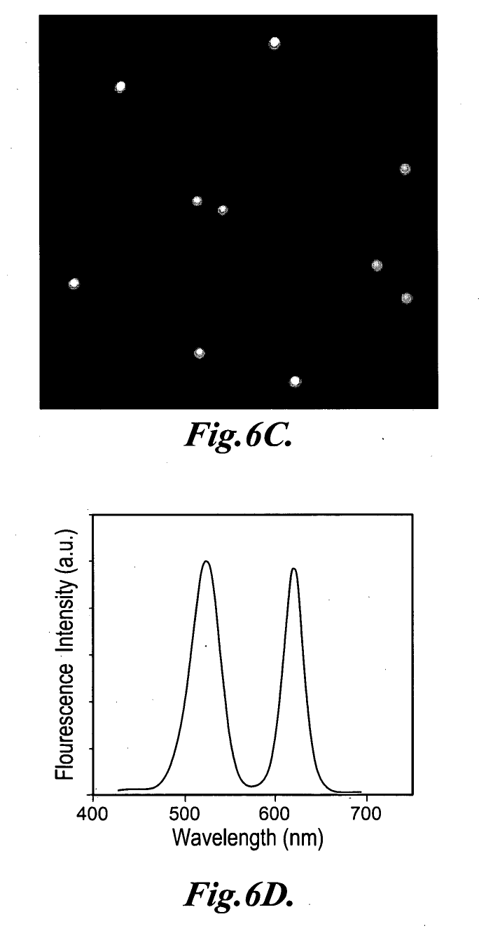

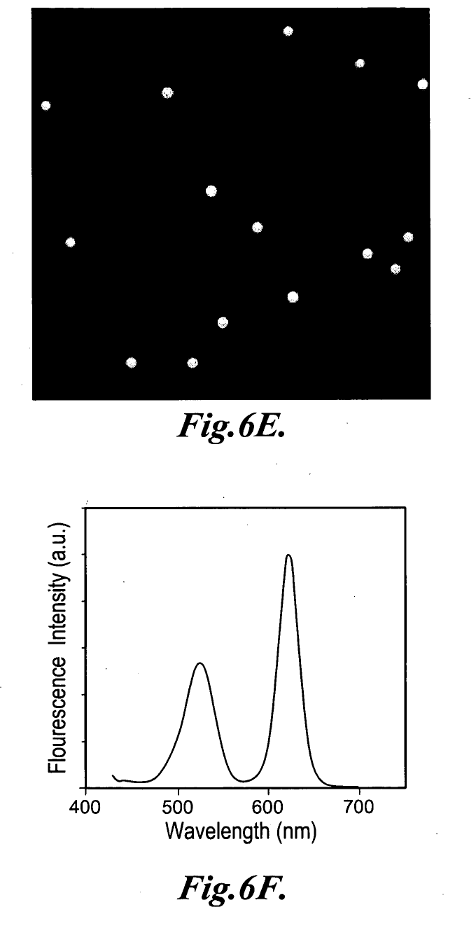

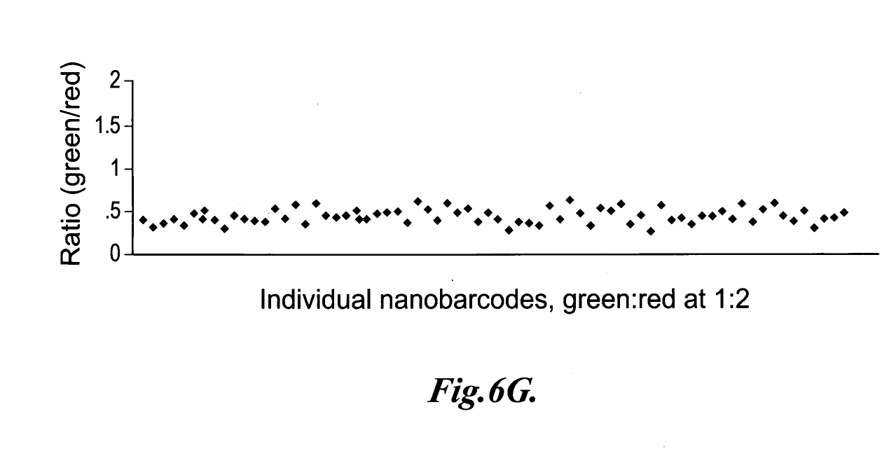

In addition to single color nanoparticle assemblies, the invention also provides homogeneous multicolor (e.g., dual-color) nanoparticle assemblies (e.g., QD-nanobarcodes). Optical barcoding based on fluorescence intensity—color multiplexing can produce more fluorescence probes using a limited number of colors. To demonstrate the feasibility, monodisperse QDs with fluorescence emission maxima at 520 nm (green) and 615 nm (red) were pre-mixed at various fluorescence intensity ratios and used in the incorporation experiment. FIGS. 6A-6F show quantitative doping results obtained from the dual-color encoded nanoparticle assemblies. Using two intensities, there are three unique intensity ratios (green/red 1:2, 1:1, and 2:1). The nanobarcodes with ratios of 2/1, 1/1, and 1/2 appear yellow, orange, and red in fluorescence imaging (FIGS. 6A-6C, respectively). Spectral measurement of nanobeads in solution confirms the three fluorescence intensity ratios as shown in FIGS. 6D-6F. To determine whether the fluorescence intensity at the ensemble-average level represents those of individual nanobarcodes, hyperspectral imaging, which is capable of examining the spectral features of a large number of nanobeads under exactly the same conditions, was employed. A standard hyperspectral imaging setup includes two major components, a passband controlling device (such as liquid crystal tunable filter and diffraction grating) and a scientific-grade monochrome charge-coupled device CCD. Controlled by data acquisition software, the filter or grating automatically steps in a certain wavelength while the camera captures a series of images (image cube) of the sample at each wavelength with constant exposure. This process is repeated for each pure spectral component to generate a spectrum library, which is then used to quantitatively deconvolute mixed colors into separate channels. A tunable filter was set to automatically step in 2 nm (tunable at 1 nm precision). The spectrum at every pixel (or binned as region-of-interest (ROI)) are extracted from the image stack.

More than 100 nanoparticle assemblies with green/red intensity ratio of 1/2 were analyzed as an example. As can be seen from FIG. 6G, the fluorescence intensity ratios are remarkably robust, although the absolute intensities could vary considerably from bead to bead (because of variations in bead size). For biomolecular imaging, ratiometric measurements are much more reliable than absolute intensities because the ratio values are not affected by simultaneous drifts or fluctuations of the individual signals. The average fluorescence intensity ratio is 0.44 in contrast to the value (0.5) measured by a fluorometer. This is because the differential spectral response of the detectors in fluorometer and hyperspectral imaging system, which are based on a photomultiplier tube and a monochrome silicon CCD, respectively.

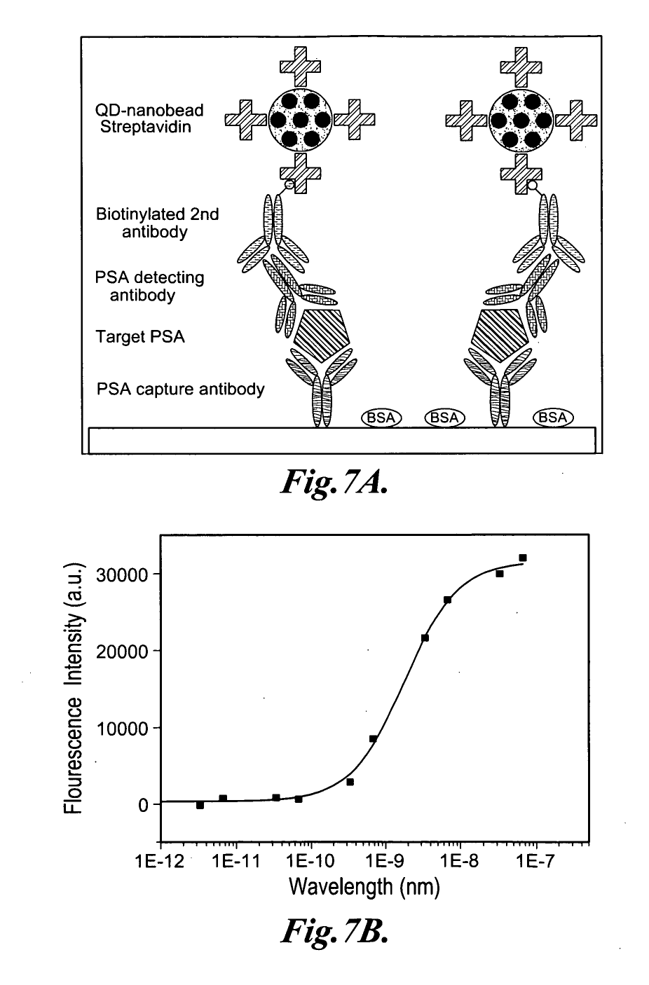

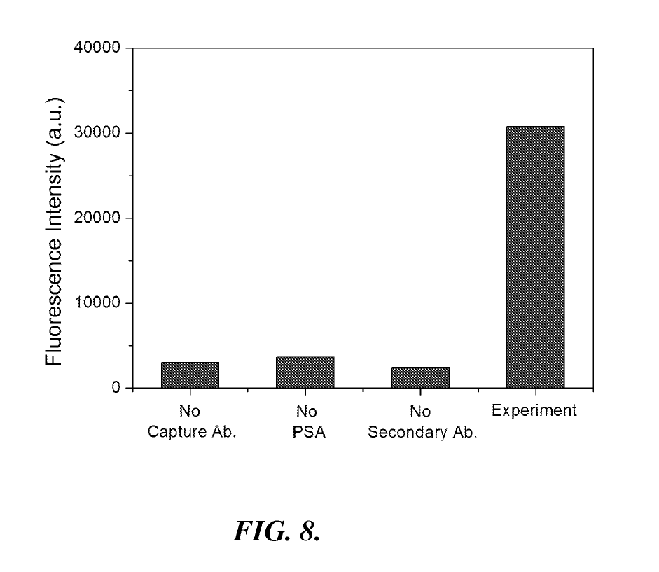

To demonstrate the application of the nanoparticle assemblies (e.g., QD-nanobeads) of the invention in biomolecular imaging and detection, nanobeads were covalently coupled to streptavidin using standard carbodiimide crosslinking chemistry and a model immunosandwich assay for PSA (prostate specific antigen) detection was performed. As schematically illustrated in FIG. 7A, rabbit-anti-human PSA polyclonal antibodies were coated on a 96-well microplate as the capture probe. Serial dilutions of human PSA (target molecules) were added into the microplate followed by incubation with monoclonal mouse anti-human PSA antibodies. Biotinylated anti-mouse IgG and the nanobead-streptavidin bioconjugates were used to generate a fluorescent signal for detection and quantification with a microplate reader. Although the off-the-shelf plate reader is not optimized to measure the fluorescence of a monolayer of nanobeads on microplate surface, FIG. 7B shows that PSA molecules still can be readily detected with detection sensitivity in the sub-nanomolar range. If spectrometers are used in conjunction with fluorescence microscopes, the perfectly focused QD-nanobeads are detectable on single bead level.

The invention provides encoded nanoparticle assemblies using nanoparticle-alternating copolymer complexes. In the present invention, nanoparticles (e.g., QDs) are pre-coated with amphiphilic polymers prior to formation of the nanoparticle assemblies, which prevents physical contact between nanoparticles. In one embodiment, a solvent mixture of THF and DMF leads to epitaxial growth of uniform and highly fluorescent nanoparticle assemblies from QDs in homogeneous solution without the need for structural templates. As a result of this nanoparticle assembly formation mechanism, a large number of multicolor QDs can be loaded into a nanobead of narrow size dispersity.

The nanoparticle assemblies of the invention can be used as a fluorescent probes and as such can be used in any fluorescent technique that employs fluorescent probes. The utility of the nanoparticle assemblies of the invention was demonstrated in a model sandwich immunoassay for PSA. The nanoparticle assemblies of the invention can be used in clinical diagnostics, as well as for ultrasensitive detection of genes, proteins, and cells in fundamental biophysics.

The following examples are provided for the purpose of illustrating, not limiting, the invention.

### Examples

### General Methods and Materials

Poly(maleic anhydride-alt-octadecene) (Mw 30,000-50,000), 2,2′-(ethylenedioxyl)bis(ethylamine), sulfo-NHS, EDC, BSA, and Tween-20 were purchased from Sigma-Aldrich (St. Louis, Mo.) and used without further purification. PSA antigen and antibodies targeting PSA were obtained from Fitzgerald Industries International, Inc. (Concord, Mass.) and Biodesign International (Saco, Me.). 96-well microplates with high-binding surface and clear bottom were a gift from Corning Incorporated Inc. (Corning, N.Y.). A UV-2450 spectrophotometer (Shimadzu, Columbia, Md.) and a Fluoromax4 fluorometer (Horiba Jobin Yvon, Edison, N.J.) were used to characterize the absorption and emission spectra of QDs and QD-nanobeads in solution. The dry and hydrodynamic radii of QDs and QD-nanobeads were measured on a CM100 transmission electron microscope (Philips EO, Netherlands) and a Zetasizer NanoZS size analyzer (Malvern, Worcestershire, UK). True-color fluorescence images were obtained with an IX-71 inverted microscope (Olympus, San Diego, Calif.) and a Q-color5 digital color camera (Olympus). Broad-band excitation in the near-UV range (330-385 nm) was provided by a mercury lamp. A longpass dichroic filter (400 nm) and emission filter (420 nm, Chroma Technologies, Brattleboro, Vt.) were used to reject the scattered light and to pass the Stokes-shifted fluorescence signals. Wavelength-resolved fluorescence spectroscopy was accomplished by coupling the fluorescence microscope with a USB4000 single-stage spectrometer (Ocean Optics, Dunedin, Fla.). For single particle fluorescence measurement, a pinhole of 200 μm diameter is placed at the objective focal plane between the spectrograph and microscope to reject the out-of-focus lights. The QDs and QD-beads were manually positioned, and spectra were recorded. The average fluorescence intensity of single nanobeads and QDs were used to calculate the number of dots per nanobead. For hyperspectral imaging, the images were obtained with a Nuance hyperspectral imaging machine that response to a spectral window from 500 to 950 nm (Cambridge Research and Instrumentation, Inc. Woburn, Mass.). The immunoassay experiments were carried out on a TECAN SAFIRE™ plate reader (Switzerland).

### Example 1

### The Preparation of Representative Nanoparticle Assemblies

In this example, the preparation of representative nanoparticle assemblies of the invention are described.

Purified QDs (0.2 μM) (OceanNanotech, Ark.) and PMAO polymers (2.5 μM) were mixed in 0.2 ml THF in a glass vial, followed by slow addition of 0.8 ml DMF under vigorous stirring. The concentration of QDs were determined by UV absorption using the molar extinction coefficients for CdSe QDs previously determined by Peng et al., Chem. Mater. 2003, 15, 2854-2860. 2,2′-(ethylenedioxyl)bis(ethylamine) in DMF (10 mM, 2.85 μl) was added into the solution to crosslink the neighboring polymer chains. The solution was stirred at room temperature for 1 h before the dialysis against Tris buffer (20 mM, pH10). The nanobeads were isolated by centrifugation and washed multiple times using borate buffer (10 mM, pH8.1) to remove free polymers and diamines in the solution.

For multiplexed nanobarcode preparation, procedure similar to the single color nanobead preparation described above was used except a mixture of green and red QDs (fluorescence emission maxima at 520 and 615 nm) at desired intensity ratios was used.

### Example 2

### Representative Nanoparticle Assembly as Fluorescent Probe in Immunoassay

In this example, a representative nanoparticle assembly of the invention is used as a fluorescent probe in an immunoassay, a sandwich immunoassay for PSA.

Conjugation of Representative Nanoparticle Assemblies to Streptavidin. Red QD-nanoparticle assemblies, prepared as described in Example 1 above, suspended in 1 ml of borate buffer (10 mM, pH 8.1) were incubated with 50 μl of EDC (1 wt %) and 100 μl of sulfo-NHS (1 wt %) for 15 mins. 10 μl of streptavidin at a concentration of 5 mg/ml was then added and incubated with QD-nanobeads for 2 hrs. The bioconjugates were spun down to remove the unbound streptavidin and this process was repeated twice. The purified bioconjugates were dispersed in borate buffer with 1 wt % BSA.

PSA sandwich immunoassay. Standard sandwich immunoassays were performed for PSA detection using QD-nanobeads. To immobilize PSA capture antibody, 96-well microplate was incubated with polyclonal rabbit-anti-human PSA antibodies (100 μl, 4 μg/ml) at 4° C. overnight. The microplate was washed with PBS buffer (10 mM, pH 7.4) with 0.05% Tween-20 (PBST). BSA molecules (100 μl, 2 wt % in PBS buffer) were added to block any un-coated regions. The microplate was again washed with PBST before a series of dilutions of human PSA were introduced into the microplate and incubated for 1 h. After removing un-bound PSA, monoclonal mouse-anti-human PSA antibodies (100 μl, 4 μg/ml) were added to form the sandwich. The microplate was subject to incubation with biotinylated anti-mouse IgG and streptavidin labeled with QD-nanobeads or FITC for fluorescence-based detection.

While illustrative embodiments have been illustrated and described, it will be appreciated that various changes can be made therein without departing from the spirit and scope of the invention.

The embodiments of the invention in which an exclusive property or privilege is claimed are defined as follows:

1. A nanoparticle assembly, comprising:
(a) a plurality of nanoparticles; and
(b) an amphiphilic polymer.

2. The nanoparticle assembly of claim 1, wherein the nanoparticles are selected from the group consisting of quantum dots, metal nanoparticles, metal oxide nanoparticles, metalloid nanoparticles, metalloid oxide nanoparticles, and combinations thereof.

3. The nanoparticle assembly of claim 1, wherein the nanoparticles are quantum dots.

4. The nanoparticle assembly of claim 1, wherein the nanoparticles are single color quantum dots.

5. The nanoparticle assembly of claim 1, wherein the nanoparticles are multicolor quantum dots.

6. The nanoparticle assembly of claim 1, wherein the nanoparticles have a hydrophobic surface.

7. The nanoparticle assembly of claim 1, wherein the nanoparticles have a diameter of from about 1 to about 100 nm.

8. The nanoparticle assembly of claim 1, wherein the amphiphilic polymer is an amphiphilic alternating copolymer.

9. The nanoparticle assembly of claim 1, wherein the amphiphilic polymer is an amphiphilic random copolymer.

10. The nanoparticle assembly of claim 1, wherein the amphiphilic polymer is an amphiphilic block copolymer.

11. The nanoparticle assembly of claim 1, wherein the amphiphilic polymer comprises a anhydride moiety and a hydrocarbon moiety.

12. The nanoparticle assembly of claim 11, wherein the hydrocarbon moiety comprises an alkyl, an aryl moiety, or an aralkyl moiety.

13. The nanoparticle assembly of claim 12, wherein the alkyl moiety comprises a C1-C24 n-alkyl moiety.

14. The nanoparticle assembly of claim 1, wherein the amphiphilic polymer has an average molecular weight of from about 500 to about 5,000,000 g/mole.

15. The nanoparticle assembly of claim 1, wherein the amphiphilic polymer is a crosslinked amphiphilic polymer.

16. A method for making a nanoparticle assembly, comprising:
(a) providing a mixture of nanoparticles and an amphiphilic polymer in a first solvent; and
(b) adding a second solvent to the mixture in a quantity sufficient to provide a nanoparticle assembly comprising the nanoparticles and amphiphilic polymer,
wherein the first and second solvents are miscible, and
wherein the polarity of the second solvent differs from the polarity of the first solvent.

17. The method of claim 16 further comprising crosslinking the nanoparticle assembly to provide a crosslinked nanoparticle assembly.

18. The method of claim 17, wherein crosslinking the nanoparticle assembly comprises crosslinking the amphiphilic polymer of the assembly.

19. The method of claim 16, wherein the amphiphilic polymer comprises a anhydride moiety and a hydrocarbon moiety.

20. The method of claim 19 further comprising hydrolyzing at least a portion of the anhydride groups of the amphiphilic copolymer to provide a nanoparticle assembly having a plurality of carboxylic acid moieties.
